(19) United States
(12) Patent Application Publication
(10) Pub. No.: US 2005/0080930 A1
(43) Pub. Date: Apr. 14, 2005

(54) Method and apparatus for processing service requests in a service-oriented architecture

(75) Inventor: Joshy Joseph, Poughkeepsie, NY (US)

Correspondence Address: William A. Kinnaman, Jr.;IBM Corporation - MS P386, 2455 South Road, Poughkeepsie, NY, 12601, US

(73) Assignee: International Business Machines Corporation, Armonk, NY (US)

(21) Appl. No.: 10/685,205

(22) Filed: Oct. 14, 2003

(51) Int. Cl. G06F 15/16

(52) U.S. Cl. 709/248

(57) ABSTRACT

In a service-oriented architecture, service requests and responses are processed in such a manner as to minimize the latency problems of existing protocols. Accumulated client service requests are packaged together with workflow information specifying the order of execution of the requests into a single message which is transmitted to the server side of the network connection. On the server side of the network connection, the individual requests are extracted from the message together with the workflow information and routed to the intended service providers, where they are executed in the order specified by the workflow information. Responses to the service requests are similarly packaged into a return message which is transmitted back to the client side, where the responses are extracted from the message and routed to the originating clients. In a preferred embodiment, individual requests and responses are conveyed as attachments to a Simple Object Access Protocol (SOAP) message.

### BACKGROUND OF THE INVENTION

1. Field of the Invention

This invention relates to a method and apparatus for processing service requests in a service-oriented architecture. More particularly, the invention relates to a method and apparatus for batching such requests and for sequential and parallel execution of such batched requests in a service-oriented architecture.

2. Description of the Related Art

Reference may be made in this specification (using bracketed numbers) to the following publications, available either in printed form or online and incorporated herein by reference:
1. W3C Note, “Web Services Description Language (WSDL) 1.1”, Mar. 15, 2001.
2. Ueli Wahli et al., WebSphere Version 5 Web Services Handbook, IBM Redbook, SG24-6891-00, March 2003.
3. W3C Working Draft, “SOAP Version 1.2 Part 0: Primer”, Jun. 26, 2002.
4. W3C Working Draft, “SOAP Version 1.2 Part 1: Messaging Framework”, Jun. 26, 2002.
5. W3C Working Draft, “SOAP Version 1.2 Part 2: Adjuncts”, Jun. 26, 2002.
6. Aaron Skonnard, “Understanding SOAP”, MSDN Library, March 2003.
7. W3C Recommendation, “Extensible Markup Language (XML) 1.0 (Second Edition)”, Oct. 6, 2000.
8. Peter Flynn (ed.), “The XML FAQ v. 3.01”, Jan. 14, 2003.
9. Sun Microsystems, Inc., “Java API for XML-Based RPC (JAX-RPC)”, printed Aug. 28, 2003.
10. Ian Foster et al., “The Physiology of the Grid: An Open Grid Services Architecture for Distributed Systems Integration”, Jun. 22, 2002.
11. Steve Tuecke et al., “Grid Service Specification”, Draft 3, Jul. 17, 2002.
12. W3C Note, “SOAP Messages with Attachments”, Dec. 11, 2000.

One of the more significant events in the field of information technology in the last several years has been the development of specifications and implementations of Web services and its close kin, Grid services. As described in reference [2] at page 7, “Web services are self-contained, modular applications that can be described, published, located, and invoked over a network. Web services perform encapsulated business functions, ranging from simple request-reply to full business process interactions.” Web services have been codified in such standards specifications as the Web Services Description Language (WSDL) [1]. Grid services [10, 11] have been defined as Web services that conform to a set of conventions (interfaces and behaviors) that define how a client interacts with a grid service. Grid services have been used to create virtual organizations (VOs) in which available computing resources (applications, processors, etc.) that are actually located remotely appear as local resources to a user.

In a service-oriented architecture like Web services, a service provider can provide a number of transport protocols used for binding to access a service. This is done in order to provide better quality-of-service (QOS) features for clients. Based on requirements on interoperability, most service-oriented architectures use the Simple Object Access Protocol (SOAP) [3, 4, 5, 6] as a lightweight protocol for exchanging structured messages. This is a simple and extensible model using the Extensible Markup Language (XML) [7, 8] as the building block. Although it is not its only application, SOAP is often used as a vehicle for transmitting remote procedure call (RPC) requests and responses (collectively, “request/responses”).

One of the major problems with using SOAP as a message exchange mechanism is its poor performance. There are numerous proposals for solving the performance problems of the SOAP protocol and its processing engine, including binary XML processing, XML processor improvements (e.g., pull parsers), precompiled messaging frameworks, and the like. The present invention addresses the problem of increased latency in the service request process of the SOAP messaging architecture. This increased latency associated with a service call is due to the inherent nature of a SOAP RPC. Normally, whenever a service request call is made, the message is formatted and bundled in the SOAP body and passed across the wire to the server. Conventionally, SOAP processors are created to handle one service call at a time similar to making a remote RPC call. This may introduce increased latency in a distributed architecture due to the granular nature of the RPC call (make a number of little calls or a big one).

Thus, when dealing with Internet-wide systems, large wide-area networks and the grid, one of the challenges is in dealing with the increased latency associated with service calls. One must make a wise decision on service call granularity (i.e., making a larger number of smaller calls or a smaller number of large calls). But most distributed systems are designed without this feature in mind (at least at the RPC API level). In the SOAP protocol, one faces the same problem with latency, as SOAP is modeled as a simple RPC call mechanism with one service call at a time. It does not address call batching requirements for a distributed system in which a set of data or jobs are processed in a single program run.

### SUMMARY OF THE INVENTION

In general, the present invention relates to a method and apparatus for processing service requests and responses (collectively, “request/responses”) in a service-oriented architecture in such a manner as to minimize the latency problems of existing protocols. Accumulated client service requests are packaged into a single message which is transmitted to the server side of the network connection. On the server side of the network connection, the individual requests are extracted from the message and routed to the intended service providers. Responses to the service requests are similarly packaged into a return message which is transmitted back to the client side, where the responses are extracted from the message and routed to the originating clients. In a preferred embodiment, individual request/responses are conveyed as attachments to a Simple Object Access Protocol (SOAP) message. Further, each message preferably contains not only requests, but workflow information specifying the order in which the requests are executed (e.g., whether given requests can be executed in parallel or must be executed sequentially.) This workflow information is used to control the order of execution of the requests at the server end, so that, for example, the execution of new requests can be initiated without requiring an additional round-trip communication with the client end.

The present invention addresses the problem of increased latency in a service-oriented architecture. In a preferred embodiment, it contemplates a service request batching and separating framework at the client and server, which batch requests or responses at each end of a communication path for transmission to the other end of the communication path and extract requests or responses received from the other end of the communication path. Additionally, a preferred embodiment of the present invention contemplates a workflow definition on the call execution process by passing workflow information to the server (as service call profiles) and executing multiple requests using that information at the server. (By “workflow information” here is meant information specifying the order of execution of the requests—for example, that request 2 is executed after request 1, that request 3 can be executed in parallel with request 2, and the like.) Finally, it contemplates a wire message format (i.e., the actual physical structure of the message, considered as a byte string) for SOAP message exchange as defined in [12] (hereinafter the “SOAP with attachment specification”) and as shown in FIG. 4, while retaining all individual call semantics. (The term “call semantics” includes not only workflow information, but also information relating to security, transactional requirements, routing, addressing and other aspects of a message call.)

This framework is defined with several assumptions in mind. First, most services are not defined and/or cannot be defined with aggregated business logic suitable for one request call rather than many single calls. Second, the movement of a batch of service calls constituting a business logic workflow from a client to the server will result in high performance. And third, clients are intelligent enough to batch calls and select the correct workflow process (conversation process).

The present invention reduces the latency problem with distributed systems by batching the request calls over the slow SOAP RPC protocol. It provides a workflow mechanism whereby clients can execute a sequence of requests at the server including parallel and sequential execution of business logic. It maintains all the request call semantics like security, correlation and transaction requirements. Clients can follow the same programming pattern as defined by client-side APIs (similar to JAX-RPC), and infrastructure handles most of the complexities. This framework provides transparency to the existing infrastructure and provides the results in a format as requested by the client. It can support synchronous or asynchronous calls. Finally, faults may be handled based on a simple invocation strategy where the fault may flow back to the client or can support complex scenarios by using workflow definitions where a fault in a service call can affect other service calls.

While the invention is preferably implemented in software, the invention may be implemented in hardware, software, or some combination of the two. When implemented in software, it may take the form of a program storage device (such as a magnetic or optical disk or semiconductor memory) readable by a machine, tangibly embodying a program of instructions executable by the machine to perform defined method steps.

### BRIEF DESCRIPTION OF THE DRAWINGS

FIG. 1 shows the client-server interaction in a conventional SOAP RPC implementation.

FIG. 2 shows the client-server interaction in a SOAP RPC implementation of the present invention.

FIG. 3 shows the data format of a SOAP message in a conventional SOAP RPC implementation.

FIG. 4 shows the data format of a SOAP message in a SOAP RPC implementation of the present invention.

FIG. 5 shows the basic service call batching engine of the present invention.

FIG. 6 shows a sample message flow from a client to a server.

FIG. 7 shows a sample message flow from a client to a server using a call batching.

### DESCRIPTION OF THE PREFERRED EMBODIMENTS

The present invention contemplates a service request batching framework for a client and server in a service-oriented architecture to better deal with the increased latency associated with the service call, by batching up the requests. This framework provides a client-side application programming interface (API) and a client-side request-batching engine to batch up the calls. The server-side framework provides facilities for service request disassembly, identification, mapping and dispatching. This framework uses SOAP (Simple Object Access Protocol) as the transport messaging protocol for the service binding. A workflow process to manage the sequential and parallel execution of service calls based on the client's preferences and/or polices is also contemplated.

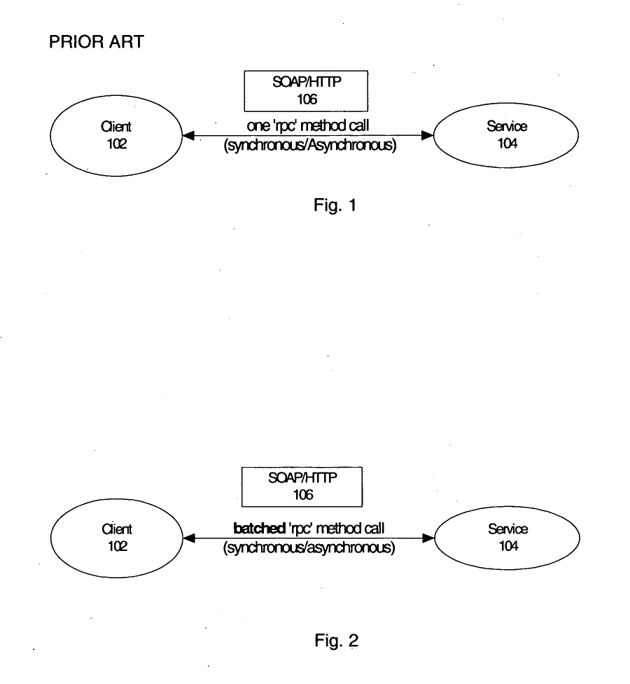

FIG. 1 shows the client-server interaction in a conventional SOAP RPC implementation, without batching. As shown in the figure, a client 102 interacts with a service provider (or simply “service”) 104 over a network 106 such as the Internet, using a SOAP/HTTP protocol (i.e., a SOAP message protocol using an HTTP transport binding). In this conventional implementation, client 102 makes remote procedure calls (RPCs) on service provider 104 by sending one message for each call. In a similar manner, service provider 104 responds to these calls by sending one message back to client 102 for each response. An RPC may be either synchronous or asynchronous. A synchronous call must await a response to the previous call before it be made. An asynchronous call, on the other hand, can be made without having to wait for a response to a previous call. In this scenario, synchronous calls can result in a considerable performance penalty if there is any appreciable latency in the transmission protocol, since they cannot overlap.

FIG. 2 shows the client-server interaction in a SOAP RPC implementation of the present invention, with request batching. In this implementation, client 102 makes remote procedure calls (RPCs) over a network 106 on service provider 104, which responds to the calls as before. However, instead of sending one message for each call, client 102 accumulates calls and sends a single message containing the accumulated calls. In a similar manner, service provider 104, rather that sending one message back to client 102 for each response, accumulates responses and sends a single message containing the accumulated responses. As in the FIG. 1 scenario, RPCs may be either synchronous or asynchronous. Here, however, the client 102 may specify any necessary ordering of the execution of the various requests with workflow information that is sent to the service provider 104 along with the requests themselves, as described below.

In both FIGS. 1 and 2, client 102 may be one of a plurality of such clients (or “service requesters”) on a client machine not separately shown. Similarly, service provider 104 may be one of a plurality of such service providers on a server machine (or “server”). Except as described herein, the particulars of the operation of client 102 and service provider 104 form no part of the present invention and are therefore not shown. Likewise, the particulars of the operation of the machines on which the client 102 and service provider 104 reside form no part of the present invention, and these machines are therefore not separately shown. Similarly, aside from being able to support the protocols described herein, the particulars of the operation of the network 106 form no part of the invention and are therefore not described.

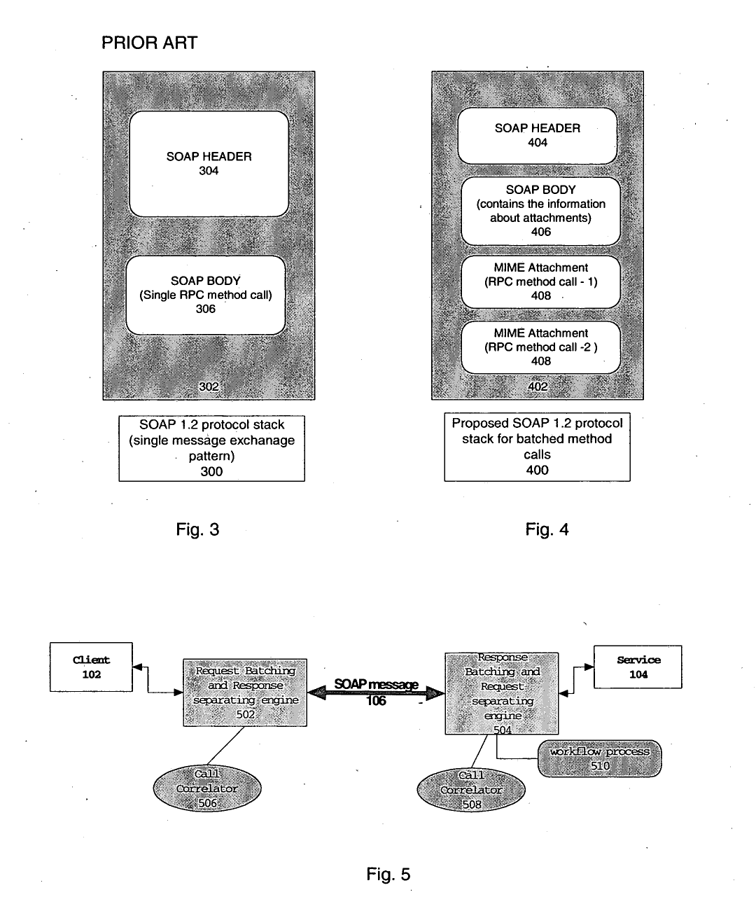

FIG. 3 shows the data format of a SOAP message 300 in a conventional SOAP implementation. The message 300 shown is a request message, but a response message would be similarly formatted. Referring to the figure, SOAP message 300 consists of an envelope 302 that contains a header 304 and a body 306. Header 304 and body 306 are each delimited by respective pairs of XML tags, as is the envelope 302. Header 304 is optional and may contain various types of control information, organized into header blocks. Body 306, on the other hand, is mandatory and contains the actual end-to end message, for example, a single RPC method call as shown.

FIG. 3 shows the logical structure of a SOAP message 300. The actual XML format of a SOAP request message 300 embedded in an HTTP request may be something like the following, in an example taken from [2]:

POST /servlet/rpcrouter HTTP/1.1
Host: www.messages.com
Content-Type: text/xml; charset=“utf-8”
Content-Length: nnnn
SOAPAction: “”
<SOAP-ENV:Envelope>
xmlns:SOAP-ENV=“http://schemas.xmlsoap.org/soap/envelope/”
<SOAP-ENV:Body>
<ns1 :getMessage xmlns:ns1=“urn:NextMessage”
SOAP-ENV:encodingStyle=“http://schemas.xmlsoap.org/soap/
encoding/”>
<UserID xsi:type=“xsd:string”>JDoe</UserID>
<Password xsi:type=“xsd:string”>0JDOE0</Password>
</ns1 :getMessage>
</SOAP-ENV:Body>
</SOAP-ENV:Envelope>

In this example, a standard HTTP header (lines 1-5) contains the URL of the SOAP server, which in this case is /www.messages.com/servlet/rpcrouter. Relative to this URL, the Web service is identified by urn:NextMessage. After the HTTP header comes a SOAP envelope 302 (lines 6-15) that contains the message to be transmitted. In this particular example, the SOAP envelope 302 contains a body 306 (lines 8-14), but no header 304. Here the method invocation is the SOAP RPC representation of a call to the method getMessage(UserID, Password) of a Web service called urn:Nextmessage residing on the SOAP server. In line 10, http://schemas.xmlsoap.org/soap/encoding/ specifies the encoding that is used to convert the parameter values from the programming language on both the client side and the server side to XML and vice versa.

FIG. 4 shows the data format of a SOAP message 400 in a SOAP implementation of the present invention. While the message 400 shown is a request message, a response message would be similarly formatted. Referring to the figure, SOAP message 400 consists of an envelope 402 that contains a header 404 and body 406, as before. In addition, however, SOAP message 400 contains one or more MIME attachments 408 (two of which are shown) as defined in the referenced SOAP with attachments specification[12]. (The logical view of FIG. 4 shows the envelope 402 as including the attachments 408. However, in the actual message format as shown in [2], the attachments 408 lie outside of the envelope 402.)

The SOAP with attachments format shown in FIG. 4 is used to package what would otherwise have been individual SOAP messages 300 into a single SOAP message 400. In a preferred embodiment, the body 306 of each individual SOAP message (corresponding to an RPC request or response) that is contained in the message 400 is embedded as a SOAP MIME attachment 408. The SOAP header 404 contains an aggregated collection of all individual SOAP message headers 304 and contains references (i.e., pointers) to the MIME attachments 408 so that the individual SOAP messages 300 can be reconstructed. Body 406, rather than containing an actual message, contains information about the attachments 408. More particularly, body 406 contains references or pointers to the MIME attachments 408 corresponding to the bodies 306 of individual SOAP messages 300. These references in body 406, when used in combination with the references to the individual headers 304 in header 404, permit the individual messages 300 to be reconstructed.

FIG. 5 shows the basic service call batching engine of the present invention. As shown in the figure, client 102 interacts with the network 106 via a request batching and response separating engine 502, while, similarly, service 104 interacts with the network 106 via a response batching and request separating engine 504. Although only a single client 102 and service provider 104 are shown, typically there may be multiple such entitles at each end of the connection. As their names imply, request batching and response separating engine 502 packages individual requests from client 102 into a single message 400 (FIG. 4) containing multiple requests for transmission over the network 106, while response batching and request separating engine 504 extracts the individual requests from the message 400 for processing by service 104. For server-bound (request) messages 400, this would entail embedding the bodies 306 of the individual request messages 300 as MIME attachments 408 to the message 400 (with pointers to the attachments 408 in the body 406) and putting the headers 304 of the individual request messages 300 in the header 404 of the message 400 (with pointers to the corresponding attachments 408). For inbound (response) messages 400, this would entail extracting the individual headers 304 from the single header 404, extracting the individual bodies 306 from the MIME attachments 408, and reconstructing messages 300 containing single RPC responses from the extracted components.

Similarly, for the return trip, response batching and request separating engine 504 packages individual responses from client 104 into a single message 400 containing multiple responses for transmission over the network 106, while request batching and response separating engine 502 extracts the individual responses from the message 400 for processing by client. Batching and separating engines 502 and 504 perform the functions described above with the assistance of respective call correlators 506 and 508. Client-side call correlator 506 ensures that responses are routed to the proper clients 102, while server-side call correlator 506 ensures that requests are routed to the proper service providers 104. In addition, a workflow process element 510 on the server side manages the order of processing of the received requests, using the workflow information received from the client end.

The present invention contemplates a framework to reduce the latency associated with a normal SOAP request call by introducing the concept of request call batching and adding the workflow semantics into the request message for the sequential and parallel execution of the requests at the server. One of the major architecture goals is to keep the client and server-side implementation intact by using the same client and server-side APIs and SOAP messaging middleware.

As noted in the summary section above, the present invention addresses the problem of increased latency in a service-oriented architecture by providing: (1) a service request call batching and separating framework at the client and server (as shown in FIG. 5); (2) a workflow definition on the call execution process, passing the workflow information to the server (as service call profiles) and executing that at the server (as shown in FIG. 5); and (3) a wire message format for SOAP message exchange as defined by the SOAP with attachment specification[12] while retaining all individual call semantics (as shown in FIG. 4).

The first of these items, the service request call batching and separating framework, supports a client-side API to define call batching requirements, workflow-related information and request control functions. This API includes starting of request batching, ending of the request batching, and associating workflow on call semantics, which includes which calls can execute in parallel, which calls should wait for the result from another call, what order the calls are to be made, etc. This workflow can be an extension to WSDL semantics or can be a new client-side service call policy language (e.g., a service call conversation language).

Preferably, the service request call batching and separating framework supports both synchronous and asynchronous client calls using synchronization primitives and call queues and associating messages with message correlators.

The client-side framework creates a SOAP message as defined by the SOAP with attachment specification and sends the SOAP message to a well known server-side framework, which is identified through the first MIME part, i.e., a SOAP body message. This SOAP message contains all the relevant information and pointers to other MIME parts (each are individual SOAP requests that are grouped here) as defined by the SOAP with attachment specification.

The client-side framework works in conjunction with a correlation engine to support message correlation, so that a successful response or a fault is returned to the correct requester. It handles service call responses and faults and dispatches them to the correct client. In the preferred embodiment it is a pluggable framework and is enabled based on the need for request call batching. Each individual request's SOAP header (each individual request may have one or more headers) is packaged in the new SOAP header of the batched request. These SOAP headers are modified to point to the MIME parts. By having a server framework as described below, SOAP header processors including intermediaries can easily interpret the SOAP message and take appropriate decisions.

The server side provides the necessary framework for separating requests and executing them under a workflow engine. The server-side framework defines a process in conjunction with a workflow engine and call correlators to understand the semantics associated with the call. These call semantics are passed along with the SOAP message in the SOAP headers. This framework can be a service endpoint (a batching service implementation) or can be a part of a service entry point (serylet or a handler). This artifact (i.e., the service entry point or endpoint) is modeled and managed based on the container requirements. In short, the server-side framework is responsible for request separating, executing (synchronous and/or parallel), results/fault mapping and batched response handling.

As mentioned earlier, this workflow information can be defined at the client- and/or server-side request-processing engine. This can be associated with the WSDL or can be defined separately as policy files. This workflow information can be simple (no order or semantics in calling methods) or can be very complex. The server using a workflow engine does the control of the execution.

The disclosed wire message format for SOAP message exchange is one of the core features of a preferred embodiment of the present invention. It defines a SOAP message exchange pattern without compromising the service call semantics associated with each call. As shown in FIG. 4, the preferred embodiment uses the message format specified in the SOAP with attachment specification [12]. Each of the requests is identified using a MIME part and can be referenced from the SOAP header and SOAP body. The SOAP body defines a RPC message to the server-side framework, which is responsible for separating each message parts and executing the requests. Each SOAP header attribute remains associated with the requests without modification. The SOAP header and MIME parts carry correlation information with the message to correlate request and response/fault. The main SOAP part can carry additional profiles needed for workflow management.

This is a pluggable framework and interested clients can use this along with their current infrastructure with no changes to their current code to support call batching and request execution at the server under a workflow process. This can reduce call latency and can result in increased performance by avoiding multiple round-trips to a server to complete a job.

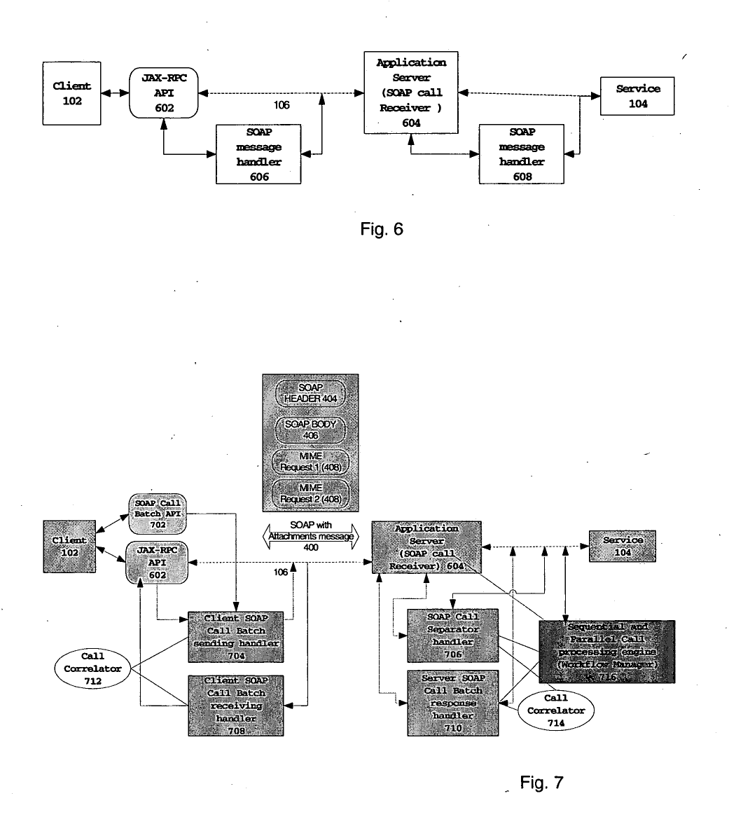

FIGS. 6 and 7 illustrate a specific implementation of the batching engine of the present invention in a Java environment using JAX-RPC handlers. More particularly, FIG. 6 shows a sample message flow from a client to a server in a conventional implementation, while FIG. 7 shows a sample message flow from a client to a server using the call batching of the present invention. Here the architecture is defined in a generic way with any service oriented framework and can be used for request/response call batching and providing workflow information profile with the request semantics.

Referring first to FIG. 6, in a conventional SOAP RPC implementation, a client 102 interfaces with the network 106 though a JAX-RPC[9] handler or API 602, while a service 104 interfaces with the network 106 through an application server or SOAP call receiver 604. On the client side, JAX-RPC handler 602 cooperates with a SOAP message handler 606 to generate SOAP messages 300 (FIG. 3) containing single RPC requests for transmission over the network 106. More particularly, JAX-RPC handler 602 generates RPC requests, while SOAP message handler 606 packages the requests into SOAP messages 300 (FIG. 3) with one request 306 per message. Similarly, on the server side, an application server or SOAP call receiver 604 cooperates with a SOAP message handler 608 to extract the single RPC request from each message 300 for processing by service 104. More particularly, application server 604 receives the SOAP messages 300, while SOAP message handler 608 extracts the individual RPC calls from each message. The functioning of these elements is similar on the return trip from the server. On the server side, application server 604 cooperates with SOAP message handler 608 to generate SOAP messages 300 containing single RPC responses for transmission over the network 106. Similarly, on the client side, JAX-RPC handler 602 cooperates with SOAP message handler 606 to extract the single RPC response from each message 300 for processing by client 102.

FIG. 7 shows how the conventional implementation shown in FIG. 6 is modified in accordance with the present invention. On the client side, the JAX-RPC handler 602 is supplemented by a SOAP call batch API 702, while SOAP message handler 606 is replaced by a client SOAP call batch sending handler 704, a client SOAP call batch receiving handler 708, and a call correlator 712. Client SOAP call batch sending handler 704 packages multiple requests 406 as attachments to a single SOAP message 400 for transmission to the server side, while client SOAP call batch receiving handler 708 extracts individual responses from return messages 400 for dispatching by call correlator 712 to the intended client 102.

On the server side, SOAP message handler 608 is replaced by a server SOAP call separator handler 706, a server SOAP call batch response handler 710, a call correlator 714, and a sequential and parallel call processing engine or workflow manager 716. Server SOAP call separator handler 706 extracts individual requests 406 from messages 400 received by application server 604 for dispatching by call correlator 714 to the intended service provider 104, while server SOAP call batch response handler 710 packages responses into a single message 400 for transmission by application server 604 back to the client side. Finally, sequential and parallel call processing engine 716 uses the workflow information from the message 400 to sequence the execution of the requests 400 received from the client side. Thus, requests that the workflow information indicates may be executed in parallel are executed in parallel, while requests that the workflow information indicates must be executed sequentially are executed sequentially.

While particular embodiments have been shown and described, various modifications will be apparent to those skilled in the art.

### APPENDIX: ABBREVIATIONS AND ACRONYMS

HTTP Hypertext Transfer Protocol.
IIOP Internet Inter-ORB Protocol.
IPC Interprocess communication
JAX-RPC Java API for XML-based RPC
JMS Java Messaging Service
MIME Multipurpose Internet Mail Extensions
QOS Quality of service.
RDF Resource Description Framework
RMI Remote Method Invocation
RPC Remote procedure call
SLA Service level agreement
SOAP Simple Object Access Protocol.
UDDI Universal Description, Discovery and Integration
WSDL Web Service Definition Language.
WSIF Web Services Invocation Framework
XML Extensible Markup Language

1. In a service-oriented architecture in which a client issues a service request to a service provider and receives a response to said service request from said service provider, said client and said service provider constituting entities at first and second ends of a communication path, a method of processing said requests and responses comprising the steps of:
accumulating a plurality of such requests or responses at one end of said communication path for transmission to the entity at the other end of said communication path;
generating a single message containing the accumulated plurality of requests or responses; and
transmitting the generated message containing the accumulated plurality of requests or responses to the entity at the other end of said communication path.

2. The method of claim 1 in which the generated message is a SOAP message containing the accumulated plurality of requests or responses as SOAP attachments.

3. The method of claim 1 in which said message is transmitted from said first end of said communication path and contains requests, said method further comprising the steps of:
receiving a message from said second end of said communication path containing a plurality of responses to service requests generated by said service provider; and
extracting individual responses from the received message for processing at said first end of said communication path.

4. The method of claim 1 in which said message is transmitted from said first end of said communication path and contains requests, said method further comprising the steps of:
receiving said message at said second end of said communication path; and
extracting individual requests from the received message for processing at said second end of said communication path.

5. The method of claim 4 in which said message contains workflow information specifying an order of execution of the requests, said method further comprising the step of:
executing the requests in the order specified by said workflow information.

6. The method of claim 5 in which said workflow information specifies whether requests in said message are executed sequentially or in parallel, said requests being executed sequentially or in parallel as specified by said workflow information.

7. In a service-oriented architecture in which a client issues a service request to a service provider and receives a response to said service request from said service provider, said client and said service provider constituting entities at first and second ends of a communication path, a method of processing said requests and responses comprising the steps of:
receiving at one end of said communication path a message from the other end of said communication path containing a plurality of such requests or responses; and
extracting individual requests or responses from the received message for processing at said one end of said communication path.

8. The method of claim 7 in which said message is received at said second end of said communication path and contains requests together with workflow information specifying an order of execution of the requests, said method further comprising the step of:
executing the requests in the order specified by said workflow information.

9. In a service-oriented architecture in which a client issues a service request to a service provider and receives a response to said service request from said service provider, said client and said service provider constituting entities at first and second ends of a communication path, apparatus for processing said requests and responses comprising:
means for accumulating a plurality of such requests or responses at one end of said communication path for transmission to the entity at the other end of said communication path;
means for generating a single message containing the accumulated plurality of requests or responses; and
means for transmitting the generated message containing the accumulated plurality of requests or responses to the entity at the other end of said communication path.

10. The apparatus of claim 9 in which said message is transmitted from said first end of said communication path and contains requests, said apparatus further comprising:
means for receiving a message from said second end of said communication path containing a plurality of responses to service requests generated by said service provider; and
means for extracting individual responses from the received message for processing at said first end of said communication path.

11. The apparatus of claim 9 in which said message is transmitted from said first end of said communication path and contains requests, said apparatus further comprising:
means for receiving said message at said second end of said communication path; and
means for extracting individual requests from the received message for processing at said second end of said communication path.

12. The apparatus of claim 11 in which said message contains workflow information specifying an order of execution of the requests, said apparatus further comprising:
means for executing the requests in the order specified by said workflow information.

13. In a service-oriented architecture in which a client issues a service request to a service provider and receives a response to said service request from said service provider, said client and said service provider constituting entities at first and second ends of a communication path, apparatus for processing said requests and responses comprising:
means for receiving at one end of said communication path a message from the other end of said communication path containing a plurality of such requests or responses; and
means for extracting individual requests or responses from the received message for processing at said one end of said communication path.

14. The apparatus of claim 13 in which said message is received at said second end of said communication path and contains requests together with workflow information specifying an order of execution of the requests, said method further comprising the step of:
executing the requests in the order specified by said workflow information.

15. A program storage device readable by a machine, tangibly embodying a program of instructions executable by the machine to perform method steps for processing requests and responses in a service-oriented architecture in which a client issues a service request to a service provider and receives a response to said service request from said service provider, said client and said service provider constituting entities at first and second ends of a communication path, said method steps comprising:
accumulating a plurality of such requests or responses at one end of said communication path for transmission to the entity at the other end of said communication path;
generating a single message containing the accumulated plurality of requests or responses; and
transmitting the generated message containing the accumulated plurality of requests or responses to the entity at the other end of said communication path.

16. The program storage device of claim 15 in which said message is transmitted from said first end of said communication path and contains requests, said method steps further comprising:
receiving a message from said second end of said communication path containing a plurality of responses to service requests generated by said service provider; and
extracting individual responses from the received message for processing at said first end of said communication path.

17. The program storage device of claim 16 in which said message is transmitted from said first end of said communication path and contains requests, said method further comprising the steps of:
receiving said message at said second end of said communication path; and
extracting individual requests from the received message for processing at said second end of said communication path.

18. The program storage device of claim 17 in which said message contains workflow information specifying an order of execution of the requests, said method further comprising the step of:
executing the requests in the order specified by said workflow information.

19. A program storage device readable by a machine, tangibly embodying a program of instructions executable by the machine to perform method steps for processing requests and responses in a service-oriented architecture in which a client issues a service request to a service provider and receives a response to said service request from said service provider, said client and said service provider constituting entities at first and second ends of a communication path, said method steps comprising:
receiving at one end of said communication path a message from the other end of said communication path containing a plurality of such requests or responses; and
extracting individual requests or responses from the received message for processing at said one end of said communication path.

20. The method of claim 19 in which said message is received at said second end of said communication path and contains requests together with workflow information specifying an order of execution of the requests, said method further comprising the step of:
executing the requests in the order specified by said workflow information.
